(19) United States
(12) Patent Application Publication
(10) Pub. No.: US 2013/0347104 A1
(43) Pub. Date: Dec. 26, 2013

(54) ANALYZING EXECUTABLE BINARY CODE WITHOUT DETECTION

(71) Applicant: RIVERSIDE RESEARCH INSTITUTE, (US)

(72) Inventors: Jason RABER, New York, NY (US); Michelle CHEATHAM, New York, NY (US); Jason CHEATHAM, New York, NY (US); Adam BRYANT, New York, NY (US); Brian KRUMHEUER, New York, NY (US); Ronald SHINKLE, New York, NY (US)

(73) Assignee: RIVERSIDE RESEARCH INSTITUTE, New York, NY (US)

(21) Appl. No.: 13/764,332

(22) Filed: Feb. 11, 2013

Related U.S. Application Data
(60) Provisional application No. 61/597,200, filed on Feb. 10, 2012.

(51) Int. Cl. G06F 21/55

(52) U.S. Cl. CPC G06F 21/55
USPC 726/22

(57) ABSTRACT

Analysis of executable binary code is performed without detection by defensive elements embedded within the executable binary code or within a system in which the executable binary code is executing. An identified suspect executable file is disassembled. Statically and dynamically analysis is performed on binary code of the disassembled executable file. An anti-anti-debugging function is implemented by executing program call functions in a manner which avoids detection of a debugging program by the defensive elements embedded within the executable binary code of the anti-debugging function of the executable binary code, thereby avoiding detection by the source of the suspect executable file.

### RELATED APPLICATION

The present patent application claims priority to Provisional Patent Application No. 61/597,200, filed Feb. 10, 2012, which is assigned to the assignee hereof and filed by the inventors hereof and which is incorporated by reference herein.

### BACKGROUND

1. Field

The disclosed technology relates to computer code analysis. More particularly, the technology relates to analyzing executable binary code without detection by defensive elements embedded with the code or within the system is which the code is executing.

2. Background

Currently, detecting and countering attacks on a computer network is difficult, since the attacker (i.e. cracker) quickly becomes aware of these activities and counters any measures to ascertain the identity of the cracker and/or take offensive actions against continued or future hacking by the particular entity or entities.

### SUMMARY

Analysis of executable binary code is performed without detection by defensive elements embedded within the executable binary code or within a system in which the executable binary code is executing. An executable file is identified and disassembled. Analysis of the executable file is performed by concurrently statically and dynamically analyzing suspect binary code of the disassembled executable file. An anti-anti-debugging function is performed, in at least the dynamic analysis, by executing program call functions in a manner which avoids detection of a debugging program by the defensive elements embedded within the executable binary code of the anti-debugging function of the executable binary code, thereby avoiding detection by the source of the suspect executable file.

### BRIEF DESCRIPTION OF THE DRAWINGS

FIG. 1 is a diagrammatic view of a system, showing the system architecture, including core and plugins.

FIG. 2 is a diagrammatic view of core components of the system.

FIGS. 3A-3D. are diagrammatic views of plugin functions. FIG. 3A shows the operation of a visualization plugin. FIG. 3B shows the operation of a data probes plugin. FIG. 3C shows the operation of an analysis plugin. FIG. 3D shows a generalized configuration of the operation of a plugin.

FIGS. 4A and 4B are diagrammatic views of COTS tools and a corresponding system. FIG. 4A shows the COTS tools, configured to perform the task of locating and analyzing a piece of malware. FIG. 4B shows the present configuration.

FIG. 5 is a diagrammatic view of an example of a profiler trace and debugger trace.

FIG. 6 is a diagrammatic view of Heuristic API

### DETAILED DESCRIPTION

Overview

There exists a need for a method for early warning, detection, and countering a cracker as soon as hacking activities begin or are in progress, so that counter activities to safeguard the computer network are pre-emptive and undetectable by the cracker. The present disclosure describes a system and method which analyzes executable binary code without detection by defensive elements embedded with the code or within the system is which the code is executing. The method is carried out using a system, including a core and plugins.

One way to identify attacks on a computer is to identify executable code which has been inserted into a computer system or to identify modifications of executable code. If an attacker becomes aware of activities involving identifying the code, it is desired that the attacker not be able to detect that the code is being analyzed.

In accordance with a first configuration, an improved method for analyzing executable binary code is provided.

In accordance with a second configuration, a method for analyzing executable binary code without detection is provided.

In accordance with a third configuration, a method is provided for analyzing executable binary code without detection by defensive elements embedded with the code or with the system in which the code is executing.

In accordance with a fourth configuration, a method is provided for analyzing executable binary code based upon an early warning detecting of a hacking activity against a computer network.

In accordance with a fifth configuration, a method is provided for analyzing executable binary code without detection by defensive elements embedded with the code or with the system in which the code is executing, including identifying a suspect executable file; disassembling the suspect executable file; and concurrently statically and dynamically analyzing suspect binary code of the disassembled executable file in a manner so as to avoid detection by the source of the suspect executable file.

In accordance with a sixth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and subverting anti-debugging protection contained within the suspect executable file.

In accordance with a seventh configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and highlighting suspicious areas of the suspect binary code to facilitate analysis of the suspect binary code.

In an eighth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and highlighting suspicious areas of the suspect binary code to facilitate analysis of the suspect binary code, wherein the subverting is performed by a kernel driver.

In accordance with a ninth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; subverting anti-debugging protection contained within the suspect executable file; and highlighting suspicious areas of the suspect binary code to facilitate analysis of the suspect binary code.

In accordance with a tenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating textual and graphical views of an assembly code of the disassembled executable file.

In an eleventh configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating interactive textual and graphical views of function-level and instruction-level run traces to allow a user to work at a high level of abstraction, only dealing with the raw trace data when a particularly interesting code segment has been identified by higher level analysis.

In accordance with a twelfth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and highlighting basic blocks in the suspect binary code that were active during a particular run trace and/or visually fading basic blocks that were not active.

In accordance with a thirteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and implementing an extensible system of heuristics that directs the user's focus to the most suspicious elements of the suspect binary code.

In accordance with a fourteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating an instruction trace view of the suspect binary code, and highlighting the suspicious areas of the instruction trace view to facilitate analysis of the suspect binary code.

In accordance with a fifteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and debugging the suspect binary code.

In accordance with a sixteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and debugging the suspect binary code, wherein the debugging is performed in a manner so as not to be detectable by the source of the suspect executable file or by the executable file itself.

In accordance with a seventeenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and comparing instruction trace views from different runs of the executable file for dynamic analysis of the suspect binary code thereof.

In accordance with a eighteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and importing a trace output from an outside source for performing the dynamic analysis of the suspect binary code.

In accordance with a nineteenth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and importing raw binary files from an outside source for analysis of the suspect binary code.

In accordance with a twentieth configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating a disassembly view of the suspect binary code to facilitate analysis of the suspect binary code.

In accordance with a twenty-first configuration, a method is provided for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating a disassembly graph view of the suspect binary code to facilitate analysis of the suspect binary code.

In accordance with a twenty-second configuration, a method for analyzing executable binary code without detection by defensive elements embedded with the code or with the system in which the code is executing, including identifying a suspect executable file; disassembling the suspect executable file; concurrently statically and dynamically analyzing suspect binary code of the disassembled executable file in a manner so as to avoid detection by the source of the suspect executable file; and generating a hex data view of the suspect binary code to facilitate analysis of the suspect binary code.

In accordance with a twenty-third configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing.

In accordance with a twenty-fourth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein detection is avoided by employing the intelligent instrumentation via instruction rerouting in both the user and kernel space.

In accordance with a twenty-fifth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin.

In accordance with a twenty-sixth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the at least one visualization plugin is at least one selected from the group consisting of graphing and highlighting.

In accordance with a twenty-seventh configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the at least one visualization plugin is at least one selected from the group consisting of graphing and highlighting, and/or wherein the at least one analysis plugin is at least one selected from the group consisting of function identification, protection identification, disassembly, and de-obfuscation.

In accordance with a twenty-eighth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the at least one visualization plugin is at least one selected form the group consisting of graphing and highlighting, and/or wherein the at least one analysis plugin is at least one selected from the group consisting of function identification, protection identification, disassembly, and de-obfuscation, and/or wherein the at least one data probe plugin is at least one selected from the group consisting of profiler, debugger, and forensics; and/or including at least one general plugin selected from the group consisting of data exfiltration and tool cloaking.

In accordance with a twenty-ninth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, including at least one general plugin selected from the group consisting of data exfiltration and tool cloaking.

In accordance with a thirtieth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the computer tool system is configured to allow the plugins to be developed separately from the rest of the tool suite.

In accordance with a thirty-first configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein the user interface of the core is configured to provide application controls and advanced visualization tools.

In accordance with a thirty-second configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein the user interface of the core is configured to provide application controls and advanced visualization tools, wherein the application controls comprise buttons and menus.

In accordance with a thirty-third configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein the user interface of the core is configured to provide application controls and advanced visualization tools, wherein the application controls comprise buttons and menus, and/or wherein the advanced visualization tools comprise data graphing and code highlighting.

In accordance with a thirty-fourth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein the database comprises a central data store for all information related to the analysis of a piece of code.

In accordance with a thirty-fifth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, wherein the database comprises a central data store for all information related to the analysis of a piece of code; and/or wherein the database is configured to allow collaboration between multiple users.

In accordance with a thirty-sixth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data.

In accordance with a thirty-seventh configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution.

In accordance with a thirty-eighth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution.

In accordance with a thirty-ninth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database.

In accordance with a fortieth configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database, and/or wherein the analysis plugin utilizes artificial intelligence techniques.

In accordance with a forty-first configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database, and/or wherein the analysis plugin utilizes artificial intelligence techniques, and/or the analysis plugin is configured to provide at least one selected from the group consisting of de-obfuscation, software protection identification, and malicious code identification.

In accordance with a forty-second configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database, and/or wherein the analysis plugin utilizes artificial intelligence techniques, and/or the analysis plugin is configured to provide at least one selected from the group consisting of de-obfuscation, software protection identification, and malicious code identification, and/or wherein the general plugin is configured to provide at least one selected from the group consisting of miscellaneous functionality, remote system penetration, and application cloaking.

In accordance with a forty-third configuration, a software tool system for use with a computer system comprises a core including a database, controller, and user interface, the tool system configured to analyze executable binary code without detection by defensive elements embedded with the code or with the system in which the code is executing, the tool including analysis tools configured for disassembly of a suspect executable file and then concurrent static and dynamic analysis of the suspect executable file; and a kernel driver configured to subvert anti-debugging protections and avoid detection by the system in which it is executing, including a plurality of plugins associated with the core, the plugins comprising at least one visualization plugin; at least one analysis plugin; and at least one data probe plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database, and/or wherein the analysis plugin utilizes artificial intelligence techniques, and/or the analysis plugin is configured to provide at least one selected from the group consisting of de-obfuscation, software protection identification, and malicious code identification, and/or wherein the general plugin is configured to provide at least one selected from the group consisting of miscellaneous functionality, remote system penetration, and application cloaking, and/or wherein the system is configured to be accessible to non-experts.

In accordance with a forty-fourth configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing.

In accordance with a forty-fifth configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing, wherein the tool system includes a plurality of plugins associated with the core, the plugins including at least one visualization plugin, at least one analysis plugin, at least one data probe plugin, and at least on general plugin.

In accordance with a forty-sixth configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing, wherein the tool system includes a plurality of plugins associated with the core, the plugins including at least one visualization plugin, at least one analysis plugin, at least one data probe plugin, and at least on general plugin, and/or wherein the at least one visualization plugin is at least one selected from the group consisting of function identification, protection identification, disassembly, and de-obfuscation.

In accordance with a forty-seventh configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing, wherein the tool system includes a plurality of plugins associated with the core, the plugins including at least one visualization plugin, at least one analysis plugin, at least one data probe plugin, and at least on general plugin, and/or wherein the at least one visualization plugin is at least one selected from the group consisting of function identification, protection identification, disassembly, and de-obfuscation, and/or wherein the at least one data probe plugin is at least one selected from the group consisting of profiler, debugger, and forensics; and/or including at least one general plugin selected from the group consisting of data exfiltration and tool cloaking.

In accordance with a forty-eighth configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing, wherein the computer tool system is configured to allow the plugins to be developed separately from the rest of the tool suite, and/or wherein the user interface of the core is configured to provide application controls and advanced visualization tools, and/or wherein the application controls comprise buttons and menus, and/or wherein the advanced visualization tools include data graphing and code highlighting, and/or wherein the database includes a central data store for all information related to the analysis of a piece of code, and/or wherein the database is configured to allow collaboration between multiple users.

In accordance with a forty-ninth configuration, a computer system is configured to analyze executable binary code without detection by defensive elements embedded within the code or within the system in which the code is executing, the system including a core with a database, a controller connected to the database, a user interface connected to the controller, and a kernel driver associated with the core, the kernel driver configured to subvert anti-debugging protections and avoid detection by the system it is executing, wherein the tool system includes a plurality of plugins associated with the core, the plugins including at least one visualization plugin, at least one analysis plugin, at least one data probe plugin, and at least on general plugin, wherein the visualization plugin is configured to show analysis data, and/or wherein the data probe plugin is configured to gather data about software code execution, and/or wherein the data probe plugin is configured to affect and control code execution, and/or wherein the analysis plugin is configured to extract high-level information from data stored in the database; and/or wherein the analysis plugin includes artificial intelligence, and/or wherein the analysis plugin is configured to provide at least one selected from the group of code de-obfuscation, software protection identification, disassembly, and malicious code identification; and/or wherein the general plugin is configured to provide at least one selected from the group consisting of miscellaneous functionality, remote control system penetration, and application cloaking; and/or wherein the system is configured to be accessible to non-experts.

Operation

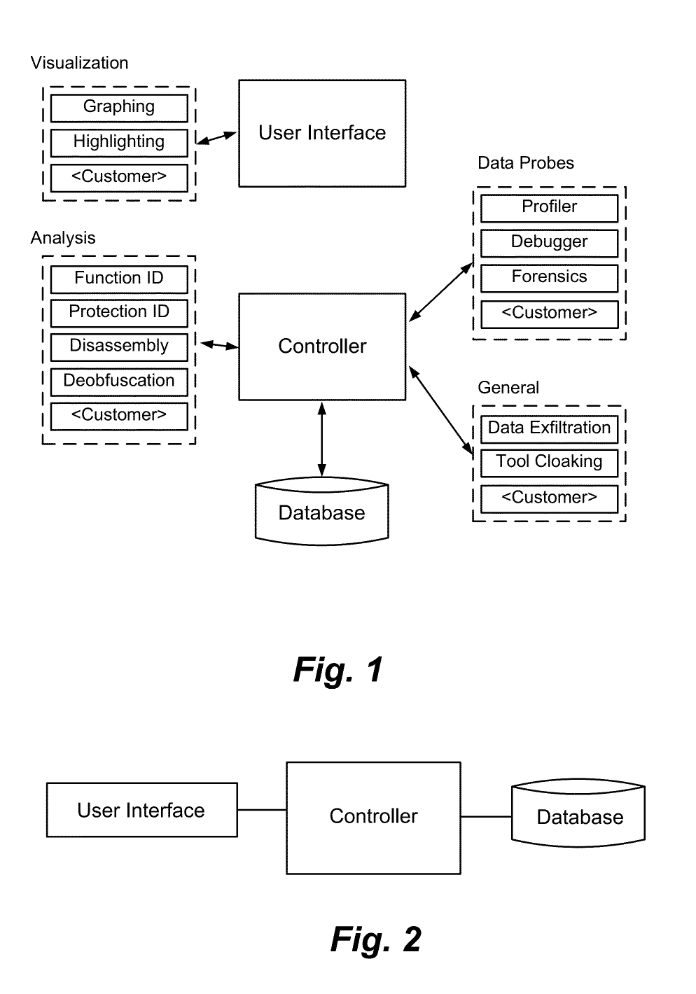

An FIG. 1 is a diagrammatic view of an example of the disclosed system, showing the system architecture, including core and plugins. The system includes a core and plugins. Specifically, the core includes an interface, controller, and database. The plugins, for example, can include visualization plugins, analysis plugins, data probe plugins, and general plugins.

The visualization plugs, for example, include graphing and highlighting. The analysis plugins, for example, include function ID, protection ID, disassembly, and de-obfuscation. The data probe plugins, for example, include profiler, debugger, and forensics. The general plugins, for example, include data exfiltration and tool cloaking.

The core components are shown in FIG. 2. Again, the core components include a user interface, controller, and database. The user interface preferably provides application controls (e.g. buttons, menus) and advanced visualization tools (e.g. data graphing, code highlighting. The controller is a communication hub for the user interface, database, and plugins. The database is preferably a central data store for all information related to the analysis of a piece of code, and allows for collaboration between multiple users.

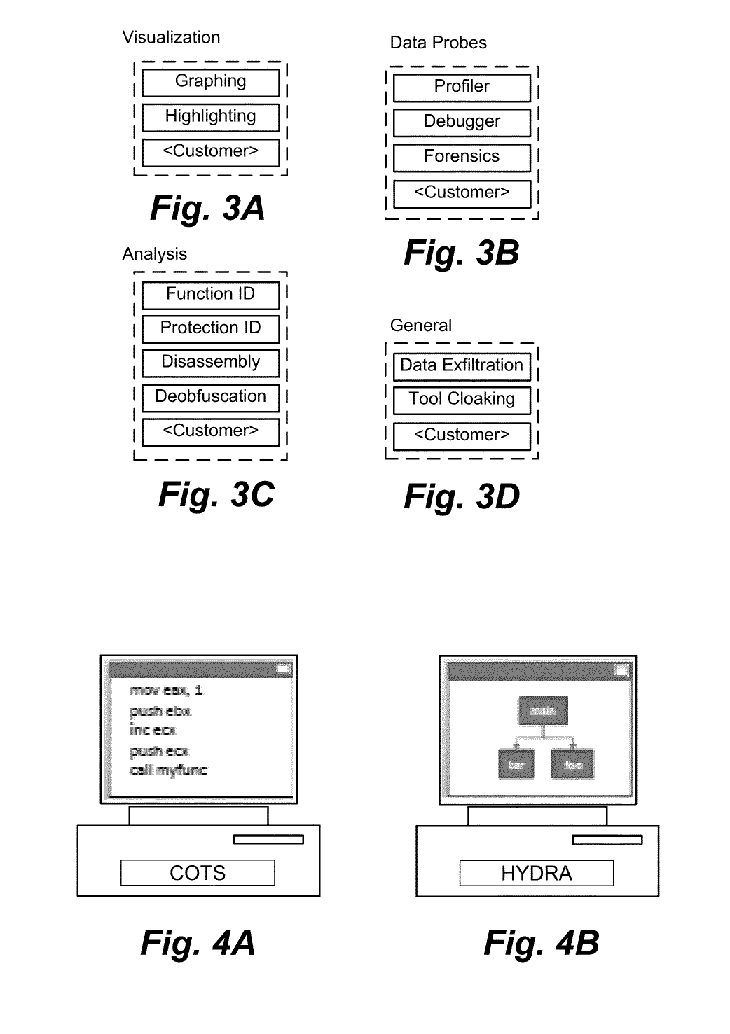

The details of the plugins are shown in FIGS. 3A-3D. FIG. 3A shows the operation of a visualization plugin. The visualization plugins shows data analysis in novel ways. FIG. 3B shows the operation of a data probes plugin. The data probes plugins are used to gather data about software code execution, and some can also affect/control code execution. The data probes plugins include application debugger, code profiler, and forensic memory probe. FIG. 3C shows the operation of an analysis plugin. As with each of these modules, there are likely to be multiple analysis plugins. The analysis plugins extract high-level information from data stored in the database, and may use advanced artificial intelligence techniques. The analysis plugins provide code de-obfuscation, software protection identification, and malicious code identification. FIG. 3D shows a generalized configuration of the operation of a plugin. In addition, general plugins can be used to provide miscellaneous functionality, remote system penetration, and application cloaking.

A comparison between COTS tools and the system is shown in FIGS. 4A and 4B. FIG. 4A shows the COTS tools, which is configured to perform the task of locating and analyzing a piece of malware. FIG. 4B shows the present configuration, which, compared with COTS tools, provides a number of improvements, including ease of use, stealth, intelligent analysis, integration of offensive and defensive capabilities, and operation at a higher level of abstraction.

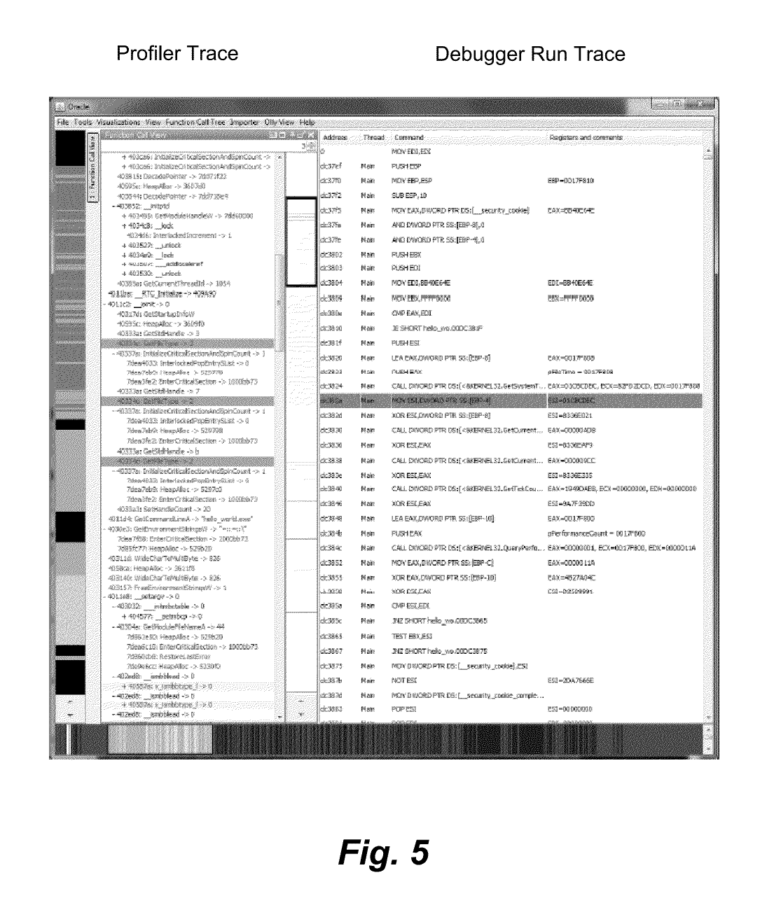

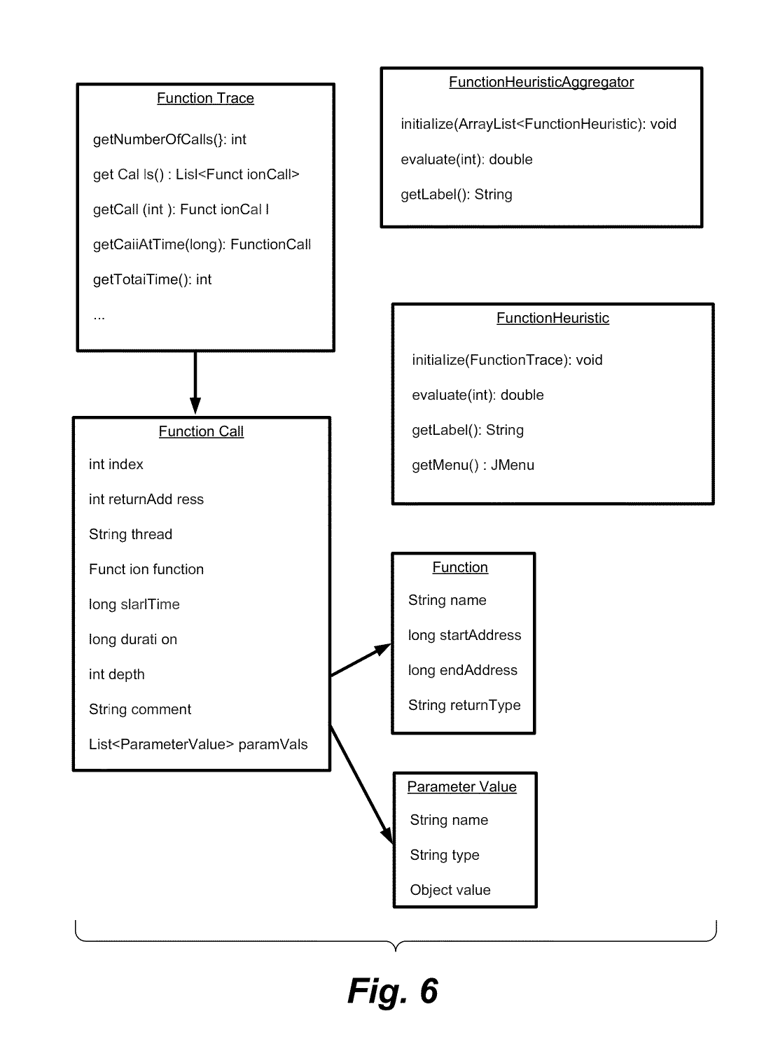

An example of the profiler trace and debugger trace are shown in FIG. 5. The method is directed to integrating new sources of information and ways of visualizing them into a binary reversed engineering process. The subject matter is focused on raising the level of abstraction, instead of slogging line by line through assembly code. FIG. 6 is a diagrammatic view of Heuristic API in which function calls are separately handled by the kernel.

The method utilizes a WINDOWS kernel driver designed to subvert anti-debugging protections. Advanced protection systems may load specialized drivers that can re-flash firmware or change the privileges of running applications, significantly increasing the penalty of detection. The method avoids detection by employing intelligent instrumentation via instruction rerouting in both user and kernel space. This method allows a reverse engineer to easily debug and profile binaries without fear of invoking protection penalties.

The method can disassemble executable files and provide textual and graphical views of the assembly code. Further, the method supports concurrent static and dynamic analysis. Function-level and instruction-level run traces can be imported from common RE tools (e.g. OllyDbg, Detours) or directly collected using tools in a tool suite.

There are a variety of visualization modules to present the dynamic information to the user in an intuitive format. For example, the tool suite contains interactive textual and graphical views of function-level and instruction-level run traces. These visualizations allow the reverse level weeds when a particularly interesting code segment has been identified by higher level analysis. In addition, run trace information is used to enhance binary views.

The tool highlights basic blocks in the binary that were active during a particular run trace while dead code fades into the background, thereby focusing the reverser's attention. The method also includes an extensible system of heuristics that directs the user's focus to the most suspicious elements of a binary (e.g. sections of code that are decrypting other code, exception handlers used as a protection).

The tool suite is a smart tool suite configured to automatically unravel the complexities of a sophisticated binary and speed up the analysis of a system or application.

The tool suite preferably utilizes a multi-headed (ring 3, ring-0, ring-#) stealthy debugger that utilizes intelligent instrumentation to reroute every instruction before it is executed. The ability to do dynamic analysis in a powerful tool in the arsenal of a reverse engineer.

Sometimes a piece of code such as malware can employ anti-debugging, encryptions, or packing measures to make dynamic analysis difficult. The instruction rerouting debugger is configured to emulate a breakpoint rather than using “INT 3” or DR0-DR7 hardware registers.

It is noted that traditional Ring-3 debuggers (OllyDbg and IDS Pro) need to register with the OS to being debugging a user application. Ring-0 kernel-level debuggers circumvent registration-based debugger checks (e.g. IsDebuggerPresent), but still use INT 3's and hardware debug registers. They also require installing device drivers (SoftICE), or require the system to boot in debug-mode (WinDbg). WinDbg also needs a second PC to control the system being debugged.

In the debugger, registration with the OS is not required. Checks for IsDebuggerPresent, CheckRemoteDebuggerPresent, GetTickCount, INT3's, and debug register use are circumvented. Further, the debugger does all its manipulations on a binary loaded in memory at runtime which avoids all file based checksums. In addition, the debugger does not require any drivers, kernel modifications, or an additional PC to control the system being debugged.

Technique

In order to avoid anti-malware detection, some malware programs include anti-debugging features to cloak its malware function. The anti-debugging features detect a debug routine, which is commonly implemented when anti-malware software is used to scan the program. The program with the anti-debugging features thereby detects a debugging pattern and responds either by perform a function which is not associated with malware, or by entering into a destruct sequence. In order to avoid the analyzed program detecting a debugging routine a kernel driver is used to subvert anti-bugging protection within the suspect executable file, in what is referred to as an anti-anti-debugging function.

The software, on scanning an executable file, highlights suspicious areas of the suspect binary code to facilitate analysis of the suspect binary code and generates textual and graphical views of an assembly code of the disassembled executable file. The software highlights basic blocks in the suspect binary code that were active during a particular run trace and/or visually fading basic blocks that were not active, thereby focusing the user's attention. The software implements an extensible system of heuristics that directs the user's focus to the most suspicious elements of the suspect binary code. The software debugs the suspect binary code, but the debugging is performed in a manner so as not to be detectable by the source of the suspect executable file or by the executable file itself.

The software imports function-level and instruction-level run traces from RE tools or directly gathering trace data using tools in an analysis tool suite being used for the analysis. The software imports raw binary files from an outside source for analysis of the suspect binary code. It then monitors execution of an application containing the suspect binary code. The software is configured to compare instruction trace views from different runs of the executable file for dynamic analysis of the suspect binary code thereof. This includes importing a trace output from an outside source for performing the dynamic analysis of the suspect binary code.

The software generates interactive textual and graphical views of function-level and instruction-level run trace to allow a user to work at a high level of abstraction. In doing so, the software only deals with the raw trace data when a particularly interesting code segment has been identified by higher level analysis. The software generates an instruction trace view of the suspect binary code, and highlighting the suspicious areas of the instruction trace view to facilitate analysis of the suspect binary code.

The software generates a disassembly view of the suspect binary code to facilitate analysis of the suspect binary code. This includes generating a disassembly graph view of the suspect binary code to facilitate analysis of the suspect binary code. The generated data may include, by way of non-limiting example, a hex data view of the suspect binary code to facilitate analysis of the suspect binary code.

This provides a software tool system for use with a computer system comprising a core including a database, controller, and user interface, the tool system configured to analyze executable binary code without detection by defensive elements embedded with the code or within the system in which the code is executing. The tool system provides analysis tools configured for disassembly of a suspect executable file and then concurrent static and dynamic analysis of the suspect executable file. The analysis plugin may be configured to extract high-level information from data stored in the database. The analysis plugin, by way of non-limiting example, utilize artificial intelligence techniques, and may be to provide code de-obfuscation, software protection identification, and/or malicious code identification.

A kernel driver is configured to subvert anti-debugging protection, as an anti-anti-debugging function. The anti-anti-debugging function enables the software to avoid detection by the system in which it is executing.

The kernel driver is used to provide intelligent instrumentation, in which detection is avoided by employing the intelligent instrumentation via instruction rerouting in both user and kernel space. The system includes plugins, which may, by way of non-limiting examples, include visualization plugins, analysis plugins and data probe plugins. The visualization plugin may, by way of non-limiting examples, can be a graphing or a highlighting plugin. The analysis plugin, by way of non-limiting examples, can include function identification, protection identification, dissembly, and de-obfuscation. The visualization plugin is configured to show analysis data. The data probe plugins can be, by way of non-limiting examples, profiler, debugger, and forensics probes. The data probe plugin may be configured to gather data about software code execution. The data probes may be configured to affect and control code execution.

The general plugins can be by way of non-limiting examples, data exfiltration and tool cloaking. The computer tool system is configured to allow the plugins to be developed separately from the rest of the tool suite. The general plugin, by way of non-limiting examples, may be configured to provide selected from the group consisting of miscellaneous functionality, remote system penetration, and application cloaking.

The user interface of the core is configured to provide application controls and advanced visualization tools. The application controls can be, by way of non-limiting examples, be computer-displayed buttons and menus. The advanced visualization tools can be, by way of non-limiting examples, data graphing and code highlighting. The system can be configured to be accessible to non-experts.

The database can be, by way of non-limiting example, a central data store for all information related to the analysis of a piece of code. The database may be configured to allow collaboration between multiple users.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for analyzing executable binary code without detection by defensive elements embedded within the executable binary code or within a system in which the executable binary code is executing, the method comprising the steps of:
identifying a suspect executable file;
disassembling the suspect executable file;
concurrently statically and dynamically analyzing suspect binary code of the disassembled executable file, and
in at least the dynamic analysis providing an anti-anti-debugging function by executing program call functions in a manner which avoids detection of a debugging program by the defensive elements embedded within the executable binary code of the anti-debugging function of the executable binary code, thereby avoiding detection by the source of the suspect executable file.

2. A method according to claim 2, further comprising using a kernel driver to subvert anti-bugging protection within the suspect executable file.

3. A method according to claim 1, further comprising:
highlighting suspicious areas of the suspect binary code to facilitate analysis of the suspect binary code and
generating textual and graphical views of an assembly code of the disassembled executable file.

4. A method according to claim 1, further comprising importing function-level and instruction-level run traces from RE tools or directly gathering trace data using tools in an analysis tool suite being used for the analysis.

5. A method according to claim 1, further comprising generating interactive textual and graphical views of function-level and instruction-level run trace to allow a user to work at a high level of abstraction, only dealing with the raw trace data when a particularly interesting code segment has been identified by higher level analysis.

6. A method according to claim 1, further comprising highlighting basic blocks in the suspect binary code that were active during a particular run trace and/or visually fading basic blocks that were not active, thereby focusing the user's attention.

7. A method according to claim 1, implementing an extensible system of heuristics that directs the user's focus to the most suspicious elements of the suspect binary code.

8. A method according to claim 1, further comprising generating an instruction trace view of the suspect binary code, and highlighting the suspicious areas of the instruction trace view to facilitate analysis of the suspect binary code.

8. A method as described in claim 1, further comprising using a kernel driver to subvert anti-bugging protection within the suspect executable file.

10. A method as described in claim 1, further comprising, on scanning an executable file, highlighting highlights suspicious areas of the suspect binary code to facilitate analysis of the suspect binary code and generates textual and graphical views of an assembly code of the disassembled executable file. The software highlights basic blocks in the suspect binary code that were active during a particular run trace and/or visually fading basic blocks that were not active, thereby focusing the user's attention. The software implements an extensible system of heuristics that directs the user's focus to the most suspicious elements of the suspect binary code. The software debugs the suspect binary code, but the debugging is performed in a manner so as not to be detectable by the source of the suspect executable file or by the executable file itself.

11. A method as described in claim 1, further comprising:
importing function-level and instruction-level run traces from RE tools or directly gathering trace data using tools in an analysis tool suite being used for the analysis, by importing raw binary files for analysis of the suspect binary code, monitoring execution of an application containing the executable code under analysis;
comparing instruction trace views from different runs of the executable file for dynamic analysis of the executable code under analysis, including importing a trace output for performing the dynamic analysis of the suspect binary code;
generating interactive textual and graphical views of function-level and instruction-level run trace to allow a user to work with an abstraction of code functions executed by the executable code under analysis, thereby performing software analysis of the raw trace data when higher level analysis identifies a particular code segment;
generating a disassembly view of the suspect binary code to facilitate analysis of the suspect binary code, including generating a disassembly graph view of the suspect binary code to facilitate analysis of the suspect binary code.

12. A method as described in claim 1, wherein the dynamic analysis comprises an artificial intelligence implementation.

13. A computer program product for use with a computer system comprising:
a core including a database, controller, and user interface, and configured to analyze executable binary code without detection by defensive elements embedded with the code or within the system in which the code executes;
analysis tools configured for disassembly of a suspect executable file and then concurrent static and dynamic analysis of the suspect executable file, the analysis plugin configured to extract high-level information from data stored in the database, and providing code de-obfuscation, software protection identification, and/or malicious code identification;
a kernel driver configured to subvert anti-debugging protection, as an anti-anti-debugging function, the anti-anti-debugging function enabling the software to avoid detection by the system during execution by providing intelligent instrumentation, in which the intelligent instrumentation reroutes instructions in both user and kernel space;
at least one plugin consisting at least one of the group consisting of:
visualization plugins, wherein the visualization plugin consists of at least one of a graphing or a highlighting plugin;
analysis plugins, wherein the analysis plugin consists of at least one of function identification, protection identification, disassembly, and de-obfuscation; and
data probe plugin configured to affect and control code execution, wherein the data probe plugin consists of at least one of a profiler, debugger, and forensics probe, and has a configuration to gather data about software code execution.

14. The computer program product as described in claim 13, wherein the dynamic analysis comprising using, as an analysis plugin, an artificial intelligence function.

15. The computer program product as described in claim 13, further comprising the use of at least one general plugin comprising at least one of the group of data exfiltration and tool cloaking.

16. The computer program product as described in claim 13, comprising a database configured to allow collaboration between multiple users.
